(19) United States
(12) Patent Application Publication
(10) Pub. No.: US 2005/0260414 A1
(43) Pub. Date: Nov. 24, 2005

(54) Coatings having low surface energy

(76) Inventor: Richard C. MacQueen, Philipsburg, NJ (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/849,398

(22) Filed: May 18, 2004

(51) Int. Cl. B32B 27/00

(52) U.S. Cl. 428/421; 428/422

(57) ABSTRACT

The present invention provides coatings that provide improved repellency for certain foreign substances, such as low viscosity liquid stainants, and reduced adhesion against other foreign materials, such as high viscosity liquids and slurries. In one embodiment, the present invention provides a coated flooring substrate, comprising a flooring substrate and a coating on the flooring substrate, wherein the coating comprises a cured resin and a low surface energy additive having a fluorocarbon or silicone functional group, in which the cured resin and the low surface energy additive each comprise a cured form of a substantially similar reactive group. The present invention also provides coating mixtures from which any of the coatings of the present invention may be made. The present invention also provides methods for making coating flooring substrates, including sheet flooring and floor tiles, having coatings made according to the present invention.

### BACKGROUND OF THE INVENTION

1. Field of the Invention

The invention relates generally to coating compositions and coatings. More specifically, the invention relates to coating compositions and coatings for floor coverings that provide a low surface energy to improve repellency and reduce adhesive properties.

2. Description of Related Art

Radiation-curable coatings are used in many applications throughout the coatings industry, such as protective coatings for various substrates, including plastic, metal, wood, ceramic, and others, and the advantages of radiation-curing compared to thermal curing are well known in the art. These coatings are typically resin-based mixtures that are usually cured using ultraviolet (UV) radiation, which may be done using a photosensitizer or photoinitiator. The resins are typically mixtures of oligomers and monomers that polymerize upon exposure to UV radiation resulting in a cured coating.

Thermally-cured coatings are also used in many applications throughout the coatings industry for various substrates such as plastic, metal, wood, ceramic and others. Thermally-cured coatings are similar to radiation-cured coatings in that they typically comprise resin-based mixtures of oligomers and monomers that polymerize upon curing. Instead of using radiation to cure or polymerize the resin, however, heat is used to effect polymerization with the use of a thermally-activated initiator.

To modify or enhance certain properties of these types of coatings, various other components may be added to the resin mixture. For example, with UV-curable coatings, a photosensitizer or photoinitiator may be added to cause cross-linkage of the polymers upon exposure to UV radiation. U.S. Pat. Nos. 6,366,670 and 6,730,388, both entitled “Coating Having Macroscopic Texture and Process for Making Same,” which are incorporated herein by reference in their entireties, describe the use of texture-producing particles to provide macroscopic texture. Flatting agents, such as silica, may be added to either type of coating to reduce or control the level of gloss in the cured coating; however, U.S. Pat. No. 4,358,476, entitled “Radiation-Curable Compositions Containing Water,” which is incorporated herein by reference in its entirety, discloses that excessive concentrations of flatting agents may result in undesirably high viscosities impeding proper application of the coating to a substrate, potential separation of the resin into separate phases, and a deleterious effect on the efficacy of the UV radiation. U.S. Pat. No. 5,585,415, entitled “Pigmented Compositions and Methods for Producing Radiation Curable Coatings of Very Low Gloss,” which is incorporated herein by reference in its entirety, describes the use of a pigmented composition and various photoinitiators that produce a uniform microscopic surface wrinkling that provides a low gloss surface without the use of flatting agents. Various other components, such as fillers, plasticizers, antioxidants, optical brighteners, defoamers, stabilizers, wetting agents, mildewcides and fungicides, surfactants, adhesion promoters, colorants, dyes, pigments, slip agents, fire and flame retardants, and release agents, may also be added to the resin mixture to provide additional functionality.

Since these coatings may be applied to substrates that are in frequent use, such as sheet flooring or tiles, incorporating stain resistance into these coatings would be useful and desirable. Many have addressed stain resistance in floor coverings by creating less absorbent surface coatings such that stainants do not penetrate deeply into the flooring substrate underneath the coating. For example, wear-resistant particles in the top coat layer have been used to address stain resistance, as described in U.S. Pat. No. 6,218,001, entitled “Surface Coverings Containing Dispersed Wear-Resistant Particles and Methods of Making the Same,” which is incorporated herein by reference in its entirety. Some have applied a hard coating over the flooring sheets or tiles. For example, U.S. Pat. No. 5,405,674, entitled “Resilient Floor Covering and Method of Making Same,” which is incorporated herein by reference in its entirety, discloses that stain resistance can be achieved through a wear layer top coat of a hard, thermoset UV-curable resin. Similarly, U.S. Pat. No. 6,423,381, entitled “Protective, Transparent UV Curable Coating Method,” which is incorporated herein by reference in its entirety, describes a hard, impervious coating that provides stain resistance to the underlying substrate. Even though these references provide stain resistance to the flooring substrate by using the coating to block absorption of the stainant as much as possible, they do not address stain resistance at the surface of the coating by repelling the stainant. Repellancy of a coating would cause a stainant to coalesce or “bead-up” on the surface, thereby reducing the total amount of surface area exposed to the stainant and providing easier clean-up of the stainant, for example, by wiping.

Based on the foregoing, there is a need for improved stain-resistant, radiation-cured and thermally-cured coatings for various substrates including plastic, metal, wood and ceramic, among others that repels stainants and has reduced adhesive properties.

### SUMMARY OF THE INVENTION

The present invention provides coatings that provide improved repellency for certain foreign substances, such as low viscosity liquid stainants, and reduced adhesion against other foreign materials, such as high viscosity liquids and slurries. The coatings of the present invention resist wetting of stainants, such as low viscosity stainants, thereby reducing the amount of surface area of the coating exposed to the stainant and enabling easy and rapid cleaning of such stainants. The coatings of also provide reduced adhesive properties so that high viscosity liquids, such as paint, or slurries, such as mud, when dried are easily removed from the coating surface.

In one embodiment, the present invention provides a coated flooring substrate, comprising a flooring substrate and a coating on the flooring substrate, wherein the coating comprises a cured resin and a low surface energy additive having a fluorocarbon functional group, in which the cured resin and the low surface energy additive each comprise a cured form of a substantially similar reactive group.

In another embodiment, the present invention provides a coated flooring substrate, comprising a soft plastic substrate and a cured coating on the soft plastic substrate, in which the cured coating comprises a cured resin and a low surface energy additive having a fluorocarbon functional group, in which the cured resin and the low surface energy additive each comprise a cured form of a substantially similar reactive group.

In another embodiment, the present invention provides a coated flooring substrate, comprising a flooring substrate and a coating on said flooring substrate, wherein the coating comprises a cured resin and a low surface energy additive having an acrylated silicone functional group, in which the cured resin and the low surface energy additive each comprise a cured form of a substantially similar reactive group.

In another embodiment, the present invention provides a coated flooring substrate, comprising a vinyl flooring substrate and a coating on the flooring substrate, wherein the coating comprises a cured acrylate resin and a low surface energy additive comprising an acrylated fluorocarbon and wherein the coating has a surface tension less than a surface tension for said coating without said low surface energy additive.

The present invention also provides coating mixtures from which any of the coatings of the present invention may be made. For example, in one embodiment, the present invention provides a coating mixture for application on a substrate, comprising a radiation-curable resin, an initiator and a low surface energy additive having a fluorocarbon functional group, in which the radiation-curable resin and the low surface energy additive each comprise a substantially similar reactive group.

The present invention also provides methods for making coating flooring substrates, including sheet flooring and floor tiles, having coatings made according to the present invention.

### BRIEF DESCRIPTION OF THE DRAWINGS

FIG. 1 illustrates a cross-sectional view of a coated substrate according to one embodiment of the present invention;

FIG. 2 provides a process flow diagram for the manufacture of a coating according to one embodiment of the present invention;

FIG. 3 illustrates a cross-sectional view of a coated sheet flooring, according to one embodiment of the present invention;

FIG. 4 presents a process flow diagram of a process for applying a coating of the present invention to sheet flooring according to one embodiment of the present invention;

FIG. 5 is a cross-sectional view of a coated floor tile, according to another embodiment of the present invention; and

FIG. 6 is a process flow diagram of a process for applying a coating of the present invention to a floor tile according to one embodiment of the present invention.

### DETAILED DESCRIPTION OF THE PREFERRED EMBODIMENTS

Generally, the present invention provides coatings, and coating mixtures from which the coatings are made, that repel foreign substances that are brought into contact with the coating surface. For example, the coatings of the present invention repel liquids, including low viscosity stainants such as magic markers, iodine, oils, etc. In these cases, the repellency results in the liquid coalescing or beading-up on the surface of the coating, thereby reducing the amount of surface area of the coating exposed to the liquid and facilitating clean-up of the liquid by, for example, wiping with a cloth. The coatings of the present invention also provide a surface to which other foreign substances will not adhere. For example, slurries, such as mud, and high viscosity liquids, such as paints, when brought into contact with the coating surface and allowed to solidify can be easily removed because there is little to no adhesion between the foreign material and the coating surface. The coatings of the present invention are also durable in that the ability to repel stainants remains on the substrate even after the coating has been abraded over time. The coatings of the present invention may be applied to any substrate, including, for example, soft plastics such as floor tiles and sheet flooring.

It should be appreciated that the term “coating” refers to the cured coating that typically would reside as an outer or exposed layer on a substrate after it has been cured or finally processed. The terms “radiation-cured” and “thermally-cured” mean after curing has occurred; therefore, the coating of the present invention, for example, may also be referred to as a “radiation-cured coating” or a “thermally-cured coating.” The terms “radiation-curable” and “thermally-curable” mean prior to curing or capable of being cured. The term “cured form” refers to the form that a particular chemical species has after curing, as opposed to its form prior to curing.

The following text in connection with the Figures describes various embodiments of the present invention. In the Figures, the same reference numbers in different Figures refer to the same function or structure. The following description, however, is not intended to limit the scope of the present invention. It should be appreciated that the coatings of the present invention have utility in providing repellency against certain foreign substances, such as low viscosity stainants, as well as in providing a sufficiently low amount of adhesion to other materials to facilitate their removal from the coating surface, such as high viscosity liquids such as paints or slurries that have dried. Regardless, the following description is in large part discussed in the context of a liquid stainant; however, it should be appreciated that any of the following coatings, coated substrates and processes have application with regard to any foreign material that comes in contact with the coatings of the present invention. Therefore, although the following description is discussed in large part in the context of a liquid stainant, such is not to be considered limiting.

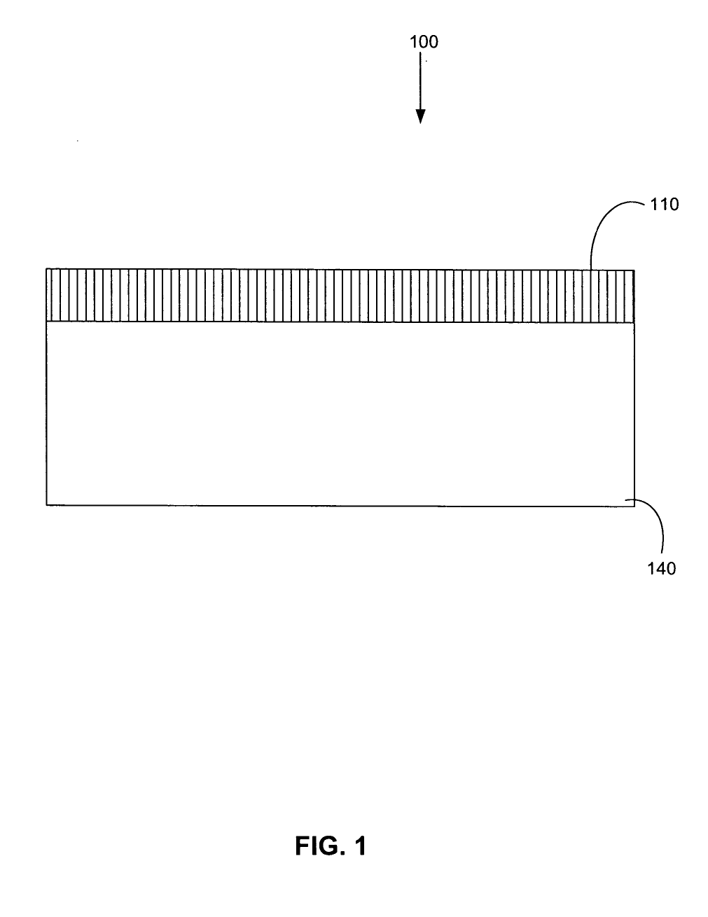

FIG. 1 illustrates a cross-sectional view of a coated substrate according to one embodiment of the present invention. FIG. 1 shows a coated substrate 100 having a coating 110 on a substrate 140. The substrate 140 can be any substrate to which a coating may be applied. As will be discussed further, in a preferred embodiment, the substrate 140 is resilient or soft plastic sheet flooring or a resilient or soft plastic floor tile, such as plasticized polyvinylchloride. Therefore, the substrate 140 may actually comprise multiple layers. For example, in the case of sheet flooring, the substrate may comprise a vinyl wear layer, a design layer, a foam or gel layer, and a felt backing. Alternatively, in the case of a floor tile, the substrate may comprise a print film layer and a backing layer comprising, for example, a vinyl calcium carbonate blend. In another embodiment, the coatings of the present invention may be applied to a floor tile having a rounded edge or any of the other floor tiles described in U.S. patent application Ser. No. 10/427,778, entitled “Resilient Floor Tile and Method of Making Same,” filed on Apr. 30, 2003, which is incorporated herein by reference in its entirety.

The coating 110 has a composition that repels liquids, for example, low viscosity stainants such as magic markers, iodine, oils, etc., as well as other materials, thereby reducing the surface area of the coating that is exposed to such liquids or other materials and facilitating easier clean-up of the stainant from the surface of the coating. As will be discussed further, and without limiting the scope of the present invention, the ability to repel such stainants is attributed to the composition of the coating 110, which is designed to provide the surface of the coating with a surface energy that is lower than that of the stainant. As a result of the lower surface energy, the stainant will be repelled from the coating 110 and will tend to “bead-up” on the surface. As noted, this will reduce the amount of surface area exposed to the stainant, thereby reducing the potential for formation of a permanent stain for two reasons. First, since the stainant will bead-up on the surface, it can be more easily and quickly cleaned, for example, by wiping with an adsorbent cloth, thereby reducing the amount of time that the surface is exposed to the stainant. Second, even if such stainant caused a permanent stain, it would be less visible since it would stain a smaller area of the coating.

The coating 110 is a cured form of a coating mixture that has been applied to the substrate 140 and subsequently cured. The coating mixture generally comprises a resin, an initiator, and a low surface energy additive, which provides the coating 110 with a lower surface energy relative to that of a stainant. The resin may be a radiation-curable resin or a thermally-curable resin, wherein the initiator is used to initiate polymerization of the resin upon exposure to either radiation or heat and is selected based upon the type of resin used in the coating mixture. Such polymerization produces a cured-form of the selected resin.

In one embodiment of the present invention, the resin is any radiation- curable resin, which is cured using radiant energy, such as ultraviolet (UV) or electron beam energy. Preferably, the radiation-curable resin comprises organic monomers, oligomers, or both. U.S. Pat. No. 4,169,167, entitled “Low Gloss Finishes by Gradient Intensity Cure;” U.S. Pat. No. 4,358,476, entitled “Radiation-Curable Compositions Containing Water;” U.S. Pat. No. 4,522,958, entitled “High-Solids Coating Composition for Improved Rheology Control Containing Chemically Modified Inorganic Microparticles;” U.S. Pat. No. 5,104,929, entitled “Abrasion Resistant Coatings Comprising Silicon Dioxide Dispersions;” U.S. Pat. No. 5,585,415, entitled “Pigmented Compositions and Methods for Producing Radiation Curable Coatings of Very Low Gloss;” U.S. Pat. No. 5,648,407, entitled “Curable Resin Sols and Fiber-Reinforced Composites Derived Therefrom;” U.S. Pat. No. 5,858,160, entitled “Decorative Surface Coverings Containing Embossed-in- Register Inlaids;” U.S. Pat. No. 6,399,670, entitled “Coating Having Macroscopic Texture and Process for Making Same;” and U.S. Pat. No. 6,730,388, entitled “Coating Having Macroscopic Texture and Process for Making Same;” each of which is incorporated herein by reference in its entirety, describe various resins, including crosslinkable (thermosetting) resins, that may be used in the present invention.

More preferably, the radiation-curable resin comprises a mixture of crosslinkable monomers and oligomers that contain on average about 1-20 reactive groups per molecule of monomer or oligomer, where the reactive group provides the ability to polymerize upon exposure to radiation. More preferably, the number of reactive groups per molecular is from 1-6. Preferred reactive groups include acrylate, vinyl, lactone, oxirane, vinyl ether, hydroxyl, methacrylate, styrene, unsaturated polyesters, thiol, unsaturated esters, maleimide, N-vinylformamide, epoxy, alcohol, and oxetanes. More preferred reactive groups include acrylate, oxirane, vinyl ether, hydroxyl, and methacrylate. More preferred monomers and oligomers are acrylates, which have the following structure: 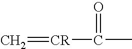
where R can be a hydrogen or alkyl, including, but not limited to, methyl, ethyl, propyl, butyl, etc. All of the foregoing radiation-curable resins are readily available or may be synthesized by procedures well known to one of skill in the art.

The oligomers and monomers can also have about 1-100 non-reactive groups per molecule of monomer or oligomer. Preferred non-reactive groups include urethane, melamine, triazine, ester, amide, ethylene oxide, propylene oxide, siloxane and perfluoroether. More preferred non-reactive groups are urethane ester, ethylene oxide, and propylene oxide.

As noted, the initiator may be any chemical capable of initiating, assisting or catalyzing the polymerization and/or crosslinking of the radiation-curable resin upon exposure to radiation. The initiator may generally be a photoinitiator or photosensitizer. Such initiators are well known in the art and may be selected based upon the resin used and the curing conditions used (e.g., curing in an inert environment or in air). Specifically, the initiator may be a free radical photoinitiator, a cationic photoinitiator, or mixtures of both of these. Preferred free radical photoinitiators include acyl phosphine oxide derivatives, benzophenone derivatives, and mixtures thereof. Preferred cationic photoinitiators include triarylsulphonium salts, diaryliodonium salts, ferrocenium salts, and mixtures thereof. A more preferred initiator is triaryl phosphine oxide.

The concentration of a particular initiator is that amount necessary to provide satisfactory curing for a given resin in the coating mixture. Such concentrations can be readily identified by one of skill in the art. A preferred concentration of the initiator is 0.01- 10 parts per hundred resin (phr), and a more preferred concentration is 0.1-4 phr.

To provide the desired surface energy to the surface of the coating, a low surface energy additive is incorporated into the coating mixture, which when ultimately cured provides a coating having a surface with a surface energy that is less than what the surface of the cured coating would have had without the surface energy additive. Preferably, the surface energy additive reduces the surface energy of an exposed surface of the cured coating to a value that is less than that of typical stainants, or other foreign substances, to which the coating may be exposed.

It should be appreciated that the surface energy of these cured coatings is what provides the desired repellency or lack of adhesion relative to a given foreign material that is in contact with the coating surface. If the surface tension of a liquid or stainant is equal to or lower than the surface energy of the coating, then the stainant will “wet-out” or spread across the surface of the coating. In this case, the stainant would cover a larger portion of the coating's total surface area, and to the extent that a permanent stain was formed, such would be more visible since it does cover a larger surface area. In addition, to the extent that clean-up or removal of the stainant from the coating surface is more difficult due to failure of the stainant to bead-up, thereby resulting in longer exposure of the coating to the stainant, the possibility of permanent staining increases. If the surface tension of the stainant is higher than the surface energy of the coating, then the stainant will generally bead-up on the surface, thereby reducing the amount of surface area exposed to the stainant. As a result, less of the coating's total surface area is exposed to the stainant, such that if a permanent stain did develop, it would not be as visible. In addition, having a stainant bead- up on the coating surface makes removal, for example, by wiping with a cloth, easier and faster, thereby reducing the amount of time that the coating is exposed to the stainant and reducing the probability of permanently staining the coating. Thus, it is desirable to reduce the surface energy of the cured coating to a value that is lower than the surface energy or tension of any material to which the coating may be exposed. For example, the surface energy of a typical UV-cured acrylic coating is greater than approximately 40 dynes/cm, whereas the surface tension of a typical magic marker is about 30 dynes/cm. Therefore, is would be desirable to reduce the coating surface energy of a typical UV-cured acrylic coating to a value below 30 dynes/cm. This would result in the ink deposited by the magic marker on the coating surface to bead-up, thereby reducing the exposed surface area of the coating and facilitating removal of the ink from the coating surface.

In addition, it is desirable to lower the surface energy of the coating to reduce the ability of the coating to adhere to certain other materials. For example, a higher viscosity liquid, which may not necessarily bead-up but, if allowed to dry, can be easily removed due to lack of or a reduced amount of adhesion to the surface of the coating.

To provide the desired reduction in surface energy, the surface energy must have a chemical structure that has a functional group capable of reducing the surface energy to provide repellency and low adhesive properties. In one embodiment, this functionality is provided by fluorocarbon or silicone functional group attached to the surface energy additive. Examples of fluorocarbon functional groups suitable for use in the present invention include any fluorocarbon, perfluoroethers and perfluoroesters. An example of a silicon functional group suitable for use in the present invention includes poly-dimethylsiloxane (PDMS). It should be appreciated, however, that any combination of functional groups may be used, including combinations of fluorocarbon functional groups and silicone functional groups.

In addition to selecting a surface energy additive that reduces the surface energy of the resulting coating to a desirable level, the selection of a suitable low surface energy additive also depends upon its ability to chemically bond to the backbone of the polymerized resin or be incorporated into the resin matrix. Such chemical bonding or incorporation into the resin matrix of the surface energy additive makes it much less susceptible to deterioration through frictional contact with the coating surface compared to other types of “stain-resistant” coatings that are only physically attached to the top surface of a coating and that wear-off through normal use. By chemically attaching the surface energy additive to the resin backbone or matrix, even with some wearing of the coating itself, some of the surface energy additive will remain and continue to provide repellency to stainants and lower adhesive properties.

To facilitate such bonding or incorporation of the surface energy additive into the resin backbone or matrix, the surface energy additive should comprise a reactive group that is that is capable of chemically bonding to the polymerized resin backbone or being incorporated into the cured resin matrix. Any of the reactive groups described above as suitable reactive groups for the resin, which participate in polymerization of the resin, may be used as the reactive group that is part of the surface energy additive.

In one embodiment, this may be accomplished by the resin and the surface energy additive having identical reactive groups. For example, if the resin comprises an acrylate monomer, the low surface energy additive would also have an acrylate reactive group. In the case of UV-curable resins, the low surface energy additive and the resin should have at least one UV-curable group, such as acrylate, methacrylate, styrene, unsaturated polyesters, thiol, vinyl ether, unsaturated esters, maleimides, N- vinylformamides, epoxy, alcohol and oxetanes. Acrylate and methacrylate are the preferred reactive groups.

In another embodiment, it is sufficient for the reactive groups of the resin and the surface energy additive to be substantially similar. Therefore, it is possible to have a surface energy additive that has a reactive group that is not chemically identical to the reactive group in the resin but is similar enough to be chemically bonded to the resin backbone or be incorporated into the resin matrix upon curing. Therefore, reactive groups that are part of the same chemical genus, but not identical, may be used. For example, the resin and the surface energy additive may separately have the following combinations of reactive groups: acrylate and methacrylate; acrylate and maleimide; styrene and unsaturated polyester; vinyl ether and unsaturated esters; thiol and olefin; epoxy and oxetane; and epoxy and alcohol. The combination of acrylate and methacrylate is most preferred.

The surface energy additive should be added to the coating mixture in an amount sufficient to provide the desired reduction in surface energy compared to the same coating without the surface energy additive. However, the concentration of the surface energy additive should be low enough so as to not negatively impact the coating's other properties, such as adhesion to the substrate, the ability to apply and spread the coating mixture on the substrate and the degree of slipperiness of the cured coating. In a one embodiment, the concentration of the surface energy additive in the coating mixture is approximately 0.05-5 weight %, which is sufficient to lower the surface energy of the resulting cured coating without negatively impacting the coating's other properties. In a preferred embodiment, the concentration of the surface energy additive in the coating mixture is approximately 0.05-1 weight %.

Based on the low surface energy additive having both a functional group to provide repellency and low adhesive properties and a reactive group to allow for incorporation into the resin backbone or matrix, examples of additives with both groups include: acrylate/methacrylate fluorocarbons, such as fluorinated acrylate/methacrylate oligomers, fluorinated diacrylate/dimethacrylate oligomers, acrylated/methacylated perfluoroethers, diacrylated/dimethacylated perfluoroethers and diacrylated/dimethacylated fluorocarbons; acrylated silicones, such as acrylated/methacrylated poly-dimethylsiloxane (PDMS) and diacrylated/dimethacrylated poly-dimethylsiloxane (PDMS). More preferred low surface energy additives include fluoro-acrylate, acrylated perfluoroether and fluorinated methacrylate oligomers. It should be appreciated, however, that any combination of these surface energy additives may be used, including one or more of any of the foregoing additives and including combinations of additives having fluorocarbon functional groups with additives having silicone functional groups.

It should be appreciated that the coating mixture and the resulting cured coating may also contain additional components such as any one or more of the following: a rheological control agent, a coupling agent, a flatting agent and texture producing particles. Each of these components is optional and may be used in any combination with any of the others.

A rheological control agent (RCA) may be added to adjust the viscosity of the coating mixture. The RCA may be inorganic particles, organic solids, and mixtures of both. The inorganic particles may be any inorganic solid having a size that is small enough to be included in the coating mixture without deleteriously affecting the coating mixture's ability to cure and adhere to a substrate. The particles should also be sufficiently small and/or closely match the refractive index of the cured coating such that the opacity of the cured coating is minimized. The particle should also not deleteriously affect the cured coating's abrasion resistance, but in some cases the RCA may improve this property. Additionally, the particles should not deleteriously affect the resistance of the cured coating to chemical attack by strongly basic aqueous media (i.e., the alkali resistance of the coating), since such alkali resistance is important in flooring materials. Preferred sizes of the inorganic particles are 1-100 nm, where 10-60 nm are most preferred.

Preferably, the inorganic particles are metal oxides, metals or carbonates, where metal oxides are preferred. More preferably, the inorganic particles are alumina, aluminosilicates, alumina coated on silica, silica, fumed alumina, fumed silica, calcium carbonate and clays. Still more preferred is alumina due to its superior hardness (for abrasion resistance) and for its greater alkali resistance relative to silica. Most preferred is nanometer-sized alumina with a particle size range of 27-56 nm due to the enhanced cured coating transparency afforded by such small particles when they are well-dispersed (e.g., through the use of an appropriate amount and type of coupling agent). However, since alumina has a higher refractive index (i.e., ˜1.7) than most organic coatings and silica (both ˜1.5), it may be envisioned that a nanometer-sized aluminosilicate material will give the optimal combination of transparency, abrasion resistance, and alkali resistance.

The inorganic particles may comprise approximately 0.1-80%, by weight, of the coating mixture, more preferably 0.1-50%, by weight, and most preferably 0.1-25%, by weight. Even more preferably, if nanometer-sized alumina is used, its concentration is approximately 0.1-40%, by weight, of the coating mixture. If fumed silica is used, its concentration is approximately 0.1-10%, by weight, of the coating mixture. If nanometer- sized crystalline silica is used, its concentration is approximately 10-30%, by weight, of the coating mixture. If exfoliated clay is used, its concentration is approximately 10-30%, by weight, of the coating mixture.

Similarly, the organic solids may be any organic solid having a size that is small enough to be included in the coating mixture without deleteriously affecting the coating mixture's ability to cure and adhere to a substrate. As with the inorganic particles, the organic particles should also not deleteriously affect the cured coating's transparency or abrasion resistance. Unlike the inorganic particles, the organic particles may dissolve or partially dissolve into the resin at elevated temperature and thicken the coating mixture upon cooling. The organic solids may be low molecular weight waxes containing functionality such as acid, amine, amide, hydroxyl, urea; polymers of ethylene glycol; polymers of propylene glycol; natural polymers such as guar, gelatin, and corn starch; polyamides including nylon; polypropylene; and mixtures of any of these. Most preferred are functional waxes. The organic solids may comprise approximately 1-50%, by weight, of the coating mixture. More preferably, the organic solids comprise between approximately 1-20%, by weight. Most preferably, if functional waxes are used, their concentration is approximately 1-10%, by weight, of the coating mixture. As will be described below in connection with the process for making the coating of the present invention, the RCA may added for several purposes.

A coupling agent or dispersing agent may also be added to the coating mixture for purpose of aiding the dispersion of the RCA in the coating mixture. The coupling agent may be any material that provides surfactant-like properties and is capable of enhancing the dispersion of the RCA in the coating mixture, in particular, the dispersion of inorganic particles. The coupling agent ideally forms a chemical and/or physical bond with the coating mixture and the inorganic particle, which improves the adhesion of the particle to the coating mixture. Generally, the coupling agent is a organo-silicon or organo-fluorine containing molecule or polymer. Preferred organo-silicon materials are organosilanes and more preferably a prehydrolyzed organosilane. The coupling agent may also be vinyl phosphonic acid or mixtures of phosphonic acid with the prehydrolyzed organosilane. The concentration of the dispersing agent may be approximately 0.05-20%, by weight, in the coating mixture, and more preferably approximately 0.05-15%, by weight.

A flatting agent may also be added to the coating mixture of the present invention. Flatting agents are well known in the art. Preferred flatting agents include organic particles having a size of approximately 0.1-100 microns, inorganic particles having a size of approximately 0.1-100 microns, and mixtures of both. When flatting agents are used, a coupling agent may be needed to obtain good dispersion in the coating mixture and good adhesion between the particle and the cured coating. For inorganic flatting agents, preferred coupling agents are organosilanes, mixtures of organosilanes, and low surface tension monomers and oligomers. For organic flatting agents, preferred coupling agent include organosilanes, mixtures of organosilanes, and low surface tension monomers and oligomers. The particle size selected is such that it is about the same size as the coating thickness or smaller. For the above embodiments, a particle size of approximately five microns is preferred. More preferred flatting agents include silica, alumina, polypropylene, polyethylene, waxes, ethylene copolymers, polyamide, polytetrafluoroethylene, urea- formaldehyde and combinations thereof. The concentration of the flatting agent may be approximately 2-25%, by weight, of the coating mixture, and more preferably is 5-20%, by weight.

Texture-producing particles may also be added to the coating mixture. (See, for example, U.S. Pat. Nos. 6,399,670 and 6,730,388, both entitled “Coating Having Macroscopic Texture and Process for Making Same,” both of which are incorporated herein by reference in their entirety.) Such texture-producing particles have an effective size or an average diameter that is larger than the coating thickness after it has been applied to the substrate. These texture-producing particles, therefore, may act to provide a macroscopic or visible texture to the coating of the present invention. These particles can be inorganic or organic materials. A coupling agent may be necessary to obtain good dispersion in the coating mixture and good adhesion between the particle and the cured coating. Preferred inorganic particles are glass, ceramic, alumina, silica, aluminosilicates, and alumina coated on silica. Preferred coupling agents for inorganic texture-producing particles are organosilanes. Preferred organic particles are thermoplastic and thermosetting polymers. For inorganic flatting agents, preferred coupling agents are organosilanes, mixtures of organosilanes, and low surface tension monomers and oligomers. For organic flatting agents, preferred coupling agents include organosilanes, mixtures of organosilanes, and low surface tension monomers and oligomers. More preferred organic particles are polyamide, including nylons, specifically, nylon-6 and nylon-12 (although one of skill in the art will recognize that other nylons may be used in the present invention), polypropylene, polyethylene, polytetrafluoroethylene, ethylene copolymers, waxes, epoxy, and urea- formaldehyde. A preferred average particle size for either organic or inorganic particles is approximately 30-350 μm, and a more preferred range is approximately 30-150 μm. A preferred concentration of particles in the coating mixture is approximately 1-30%, by weight, and a more preferred concentration is approximately 5-15% by weight.

In a most preferred embodiment, both the flatting agent and texture- producing particles are nylon particles. Because nylon tends to float to the top of a liquid resin, they remain near or at the top of the cured coating surface. During the manufacturing process, the nylon particles remain physically intact, which is important in affecting the cured coating's surface characteristics. Since a low surface energy additive is also incorporated into the resin mixture, which may increase slipperiness, the intact nylon particles near or at the top of the cured coating's surface may help to counterbalance such slipperiness.

A preferred embodiment of a UV-curable coating mixture of the present invention comprises, by weight, approximately 86% of a radiation-curable resin mixture comprising, by weight, 46% urethane acrylate (ALUA 1001, available from Congoleum Corporation, Mercerville, N.J.), 8% ethoxylated diacrylate monomer (SR 259 available from Sartomer, Exton, Pa.), 11% ethoxylated trimethylol propane triacrylate monomer (SR 454 available from Sartomer, Exton, Pa.), 21% tripropylene glycol diacrylate monomer (SR 306 available from Sartomer, Exton, Pa.), and 0.1% triaryl phosphine oxide (LUCIRIN TPO available from BASF, Charlotte, N.C.); 0.5% nano-sized alumina RCA having a particle size distribution in the range of 27-56 nm (NANOTEC ALUMINA 0100 available from Nanophase Technologies Corp., Burr Ridge, Ill.); 0.08% prehydrolyzed silane as an RCA coupling agent (CONSURF-1 available from Congoleum, Mercerville, N.J.); 8.1% flatting agent comprising 5 micron nylon particles (ORGASOL 2001 UD available from Atofina, Philadelphia, Pa.); 5% texture-producing particles comprising 50 micron nylon-12 particles (ORGASOL 2002 ES 5 available from Atofina, Philadelphia, Pa.); and 0.25% fluorinated acrylate oligomer as the low surface energy additive (CN 4000 available from Sartomer, Exton, Pa.). As such, a preferred cured coating according to the present invention is that coating produced using the above preferred coating mixture. In particular, this coating mixture and the resulting cured coating are preferred for use on sheet flooring and floor tile as substrates.

In another embodiment of the present invention, the coating mixture generally may comprise a thermally-curable resin, a thermal initiator, and a low surface energy additive. The thermally-curable resin may be any resin capable of being cured using thermal energy. More preferably, the thermally-curable resin comprises a mixture of crosslinkable monomers and oligomers that contain on average from 1-20 reactive groups per molecule of monomer or oligomer, where the reactive group provides the functionality for polymerization upon exposure to heat. More preferably, the number of reactive groups per molecular is from 1-6. Preferred reactive groups include acrylate, vinyl, lactone, oxirane, vinyl ether, hydroxyl, methacrylate, styrene, unsaturated polyesters, thiol, unsaturated esters, maleimide, N-vinylformamide, epoxy, alcohol, and oxetanes. More preferred reactive groups include acrylate, oxirane, vinyl ether, hydroxyl, and methacrylate. More preferred monomers and oligomers are acrylates, which have the following structure: 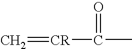
where R can be a hydrogen or alkyl, including, but not limited to, methyl, ethyl, propyl, butyl, etc. These thermally-curable resins are readily available or may be synthesized by procedures well known to one of skill in the art.

The oligomers and monomers can also have 1-100 non-reactive groups per molecule of ester, amide, ethylene oxide, propylene oxide, and siloxane. More preferred non-reactive groups are urethane, ethylene oxide, and propylene oxide.

The thermally-curable resins preferably include organic monomers, oligomers, or both. U.S. Pat. No. 4,169,167, entitled “Low Gloss Finishes by Gradient Intensity Cure;” U.S. Pat. No. 4,358,476, entitled “Radiation-Curable Compositions Containing Water;” U.S. Pat. No. 4,522,958, entitled “High-Solids Coating Composition for Improved Rheology Control Containing Chemically Modified Inorganic Microparticles;” U.S. Pat. No. 5,104,929, entitled “Abrasion Resistant Coatings Comprising Silicon Dioxide Dispersions;” U.S. Pat. No. 5,585,415, entitled “Pigmented Compositions and Methods for Producing Radiation Curable Coatings of Very Low Gloss;” U.S. Pat. No. 5,648,407, entitled “Curable Resin Sols and Fiber-Reinforced Composites Derived Therefrom;” U.S. Pat. No. 5,858,160, entitled “Decorative Surface Coverings Containing Embossed-in-Register Inlaids;” U.S. Pat. No. 6,399,670, entitled “Coating Having Macroscopic Texture and Process for Making Same;” and U.S. Pat. No. 6,730,388, entitled “Coating Having Macroscopic Texture and Process for Making Same;” incorporated herein by reference, describe various resins, including crosslinkable (thermosetting) resins, that may be used in the present invention.

As noted, the initiator may be any chemical capable of initiating, assisting or catalyzing the polymerization and/or crosslinking of the radiation-curable resin upon exposure to heat. Preferably, a free radical thermal initiator comprising an organic peroxide, such as tertiary-butyl peroxybenzoate, is used.

As described above for radiation-curable coatings made according to the present invention, a surface energy additive is also added to the thermally-curable coating mixture. The same surface energy additive as used in the radiation-curable coatings can be used in the thermally-curable coating mixtures and should possess the same properties and functions as described above for radiation-curable coating mixtures. In addition, the same rheological control agents, coupling agents, flatting agents and texture-producing particles may also be added as described above for the radiation-curable coating mixtures.

It should be appreciated that many additional components known in the art may be added to any of the foregoing coating mixtures and coatings of the present invention. These additional components may include fillers, plasticizers, antioxidants, optical brighteners, defoamers, stabilizers, wetting agents, mildewcides and fungicides, surfactants, adhesion promoters, colorants, dyes, pigments, slip agents, fire and flame retardants, and release agents.

Moreover, it should be appreciated that the concentrations of the various non-reactive groups and components in the cured coating are assumed to be the same in the coating mixture. As will be described below, the coating of the present invention is made by applying the coating mixture to a substrate followed by either radiation curing or thermal curing. Therefore, it is assumed that the concentrations of the various non-reactive groups and components in the coating mixture will not change substantially during curing and will remain substantially the same. However, those skilled in the art will recognize that other factors, such as coating application processing conditions, may induce some degree of variability in these concentrations.

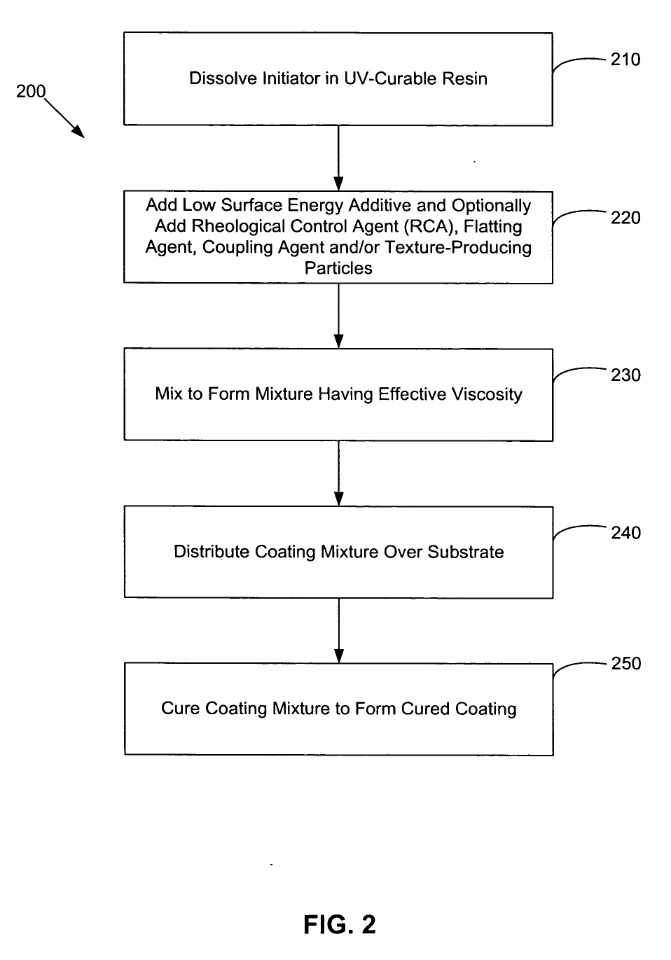

FIG. 2 provides a process flow diagram for the manufacture of a coating according to one embodiment of the present invention. The coating manufacturing process 200 is described in the context of a radiation-curable resin; however, the same process could be used for a thermally-curable resin with the exception of using heat rather than radiation to cure the resin.

In the step 210 an initiator is dissolved in a radiation-curable resin. The initiator and the resin may be mixed in any manner typically used in the art such that the initiator is dissolved into the resin phase. In the step 220, a low surface energy additive, such as those described above, and optionally any RCA, coupling agent, flatting agent, or texture-producing particles are added. It should be appreciated that if particles and a coupling agent are used, both may be added to the mixture either simultaneously or sequentially, without pre-treating the particles with the coupling agent. This avoids the use of a solvent that later upon evaporation may create diffusion pathways for staining materials to diffuse through and stain the coating. In some cases, it is desirable to make a concentrated mixture of RCA, coupling agent, flatting agent, and/or texture-producing particles in a liquid medium and dilute it with the coating mixture. This concentrate is called a master batch and is well known in the art.

In the step 230, all of the components are mixed to produce the coating mixture. Step 230 may be accomplished using a Cowles blade mixer, ultrasonic probe or other high shear mixer. It should be appreciated that during mixing the temperature of the mixture should not be allowed to increase significantly. For example, increases in temperature to approximately 100° C. may result in thermal reaction of the resin causing gelation. In cases where an organic solid is used as a RCA, the temperature during mixing should be allowed to increase to a temperature that is adequate to dissolve the organic solid, for example, approximately 70° C. The temperature should then be reduced to ambient temperature.

In the step 240, any radiation-curable coating mixture made according to the present invention is applied to and distributed across the surface of a substrate. Step 240 requires that the coating mixture is initially applied to the substrate surface and then distributed across the surface. Application of the coating mixture to the surface of the substrate may be accomplished by any means known in the art. For example, the coating mixture may be pumped and placed on the substrate using a slot die.

Distributing the coating mixture across the substrate surface may be accomplished using any means known in the art. It should be appreciated that it is preferred to uniformly distribute the coating mixture across the substrate surface. One method for distributing the coating mixture uniformly across the substrate surface is by use of a roll coater. The roll coater both applies and distributes the coating mixture on the substrate.

In the step 250 the coating mixture that has been distributed over the substrate surface is cured using radiation. This curing step acts to polymerize the resin in the coating mixture resulting in a cured coating that is adhered to the substrate surface. Step 250 may be conducted under conditions typical of radiation-curing processes depending upon the particular radiation-curable resin and initiator used. For example, step 250 may be conducted using radiation lamps in an inert atmosphere. It should be appreciated that if a matte finish is desired, the radiation lamps can be used in an ambient atmosphere followed by an inert atmosphere. Thus, a matte finish can be superimposed, if a flatting agent is used.

It should be appreciated that process steps described in connection with FIG. 2 are equally applicable to the use of a thermally-curable coating mixture made according to the present invention. In this case, the step 210 would be directed to a thermally-curable resin and a thermal initiator, and the step 250 would be directed to thermal curing and the formation of a thermally-cured coating. It should also be appreciated that the foregoing description of the methods used to generate the coatings of the present invention in the context of a radiation-cured coating is equally applicable to the generation of the thermally- cured coatings of the present invention.

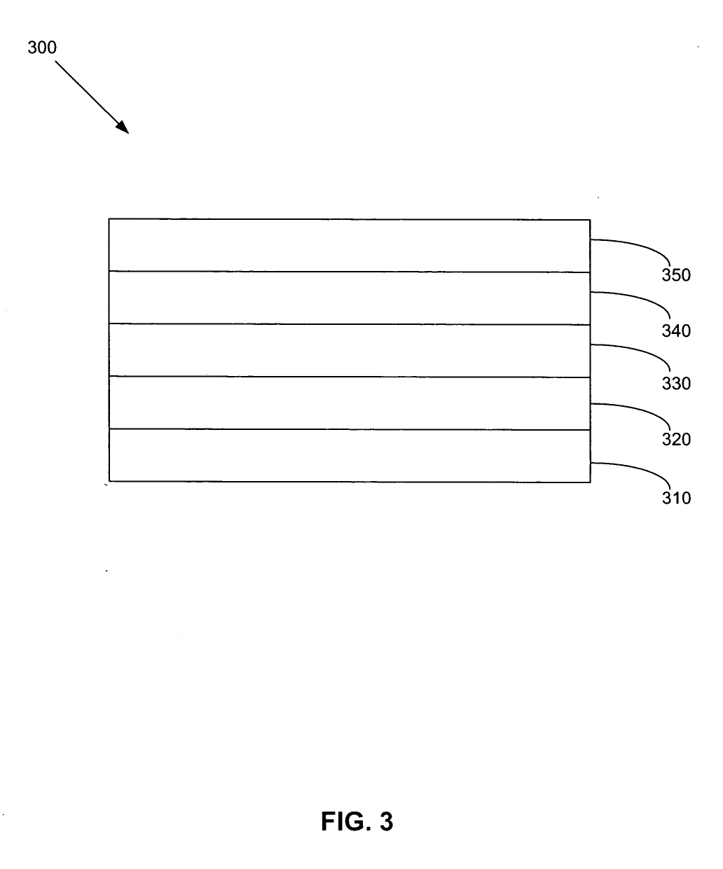

FIG. 3 illustrates a cross-sectional view of a coated sheet flooring, according to one embodiment of the present invention. The coated sheet flooring 300 comprises a bottom layer 310 made of felt or cellulose paper. On top of the bottom layer 310 is a gel layer 320, typically comprising a polyvinyl chloride plastisol, and on top of this gel layer 320 is a print layer 330 that may or may not comprise ink to provide a decorative pattern (not shown). On top of the print layer 330 is a clear wear layer 340, which is typically made of a polyvinyl chloride plastisol. On top of the wear layer 340 is a top coat 350, which may be any of the coatings of the present invention. A preferred construction of this sheet flooring comprises a felt layer of approximately 23.5 mils, a gel layer of approximately 57 mils, a print layer of nominal or relatively small thickness, a wear layer of approximately 20 mils, and a top coat of approximately 1-1.3 mils.

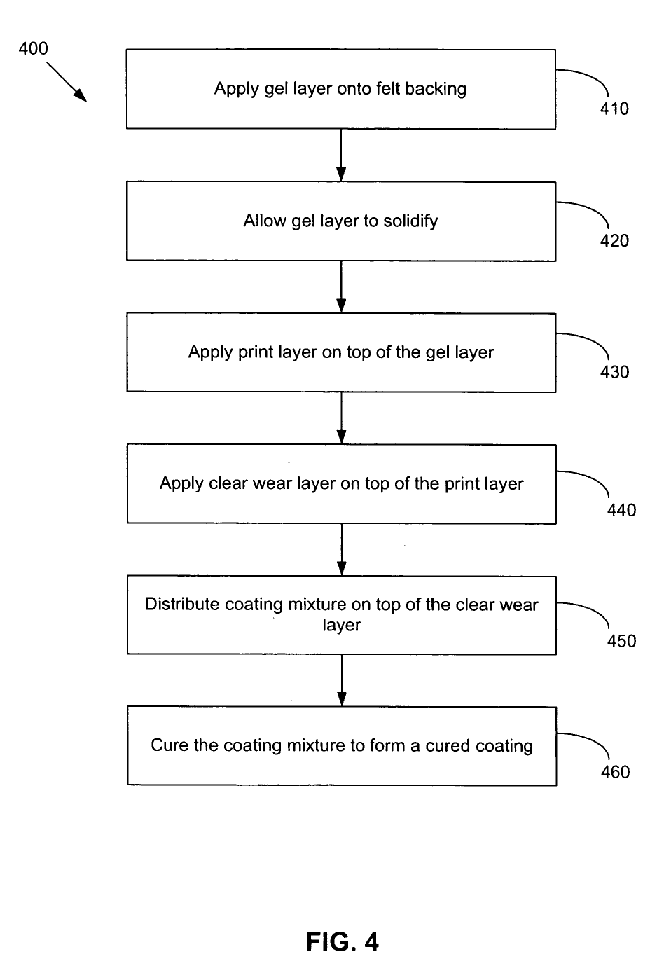

FIG. 4 presents a process flow diagram of a process for applying a coating of the present invention to sheet flooring according to one embodiment of the present invention. The process 400 begins with the step 410 in which a felt backing is coated with a gel layer, typically a plastisol. In the step 420 this gel layer is then solidified. In the step 430, a print layer comprising a decorative print may then be applied to the top of this gel layer. The inks used in printing may be used in cooperation with the gel layer to inhibit a blowing agent that may be used in the gel layer to subsequently enable chemical embossing of the gel layer to provide additional aesthetics. Additionally, as provided in the step 440, a clear wear layer, in the form of another plastisol-type layer, may be applied on top of the print layer to provide protection for the decorative print or chemically embossed effects. In the step 450, any coating mixture made according to the present invention is applied to the clear wear layer. Finally, in the step 460 the coating mixture is cured.

In a preferred embodiment of the sheet floor manufacturing process, a 6 to 16 feet wide felt is coated with a liquid polyvinly chloride (PVC) plastisol (e.g., PVC resin particles dispersed in plastisizers (e.g., phthalates)). Mixed into this liquid plastisol, which is called a gel layer, is a blowing agent (e.g., azodicarbonamide) and a catalyst (e.g., zinc oxide). The catalyst lowers the decomposition temperature of the azodicarbonamide and increases the amount of nitrogen gas produced by the azodicarbonamide decomposition. The liquid gel layer on felt is then gelled at a temperature below the decomposition temperature of the blowing agent (approximately 300° F.) to provide a solid non-foamed and smooth surface for printing. After the gel layer is solidified, it is printed with the desired design using water-based inks, thereby creating the print layer. In some of the inks, a compound that inhibits the decomposition of the blowing agent is present. After the ink is printed, the PVC-coated felt is wound up and allowed to age about 24 hours. This aging allows the inhibitor in the ink to diffuse into the gel layer, where it is believed that the inhibitor reduces the effectiveness of the catalyst.

The gel coated felt is then unwound on another production line where it is coated with another PVC plastisol that is formulated to be a clear layer when solidified. This liquid layer, called the wear layer since it protects the print from wearing, is then solidified (referred to as fused) at 385° F. for about 1.5 minutes. At this temperature, the azodicarbonamide blowing agent is activated in the gel layer resulting in the foaming of this layer which increases its thickness by forming a cell structure due to the gas formation. The ratio of the gel thickness before and after foaming is called the blow ratio, which is typically 2:1 to 4:1. In the areas of the gel directly below the ink containing inhibitor, less foaming occurs giving less of an increase in gel layer thickness. This process results in an embossing effect (i.e., chemical embossing). After the warm fused sheet leaves the oven it can be mechanically embossed for additional aesthetics.

While these PVC wear layers provide protection to the underlying print, they are susceptible to scuffing and marring due to the softness of the thermoplastic. To reduce the scuffing, these PVC surfaces can be either waxed or coated with a thermosetting coating (known as a “no wax coating”) such as a radiation-curable coating (e.g., urethane acrylate) or thermally-curable coating made according to the present invention. If the flooring is to have a no wax finish, a radiation-curable or thermally-curable coating is then applied after the wear layer is cleaned with an acetic acid solution to remove dirt and oils. Excess coating is applied to the wear layer using a roller, where the roller transfers the coating from a trough to the wear layer surface. An air knife immediately meters the excess coating, where the excess is recycled back into the trough. The process conditions of the coating application and metering such as line speed (dwell time under the air knife), air knife pressure, angle of air knife relative to the web, gap between air knife and web, and the speed of the application roll relative to the line speed may also affect the coating texture. The uncured metered coating is then cured thermally or with radiation using, for example, UV lamps where both air and nitrogen atmospheres may be used for UV curing depending on the gloss of the coating desired.

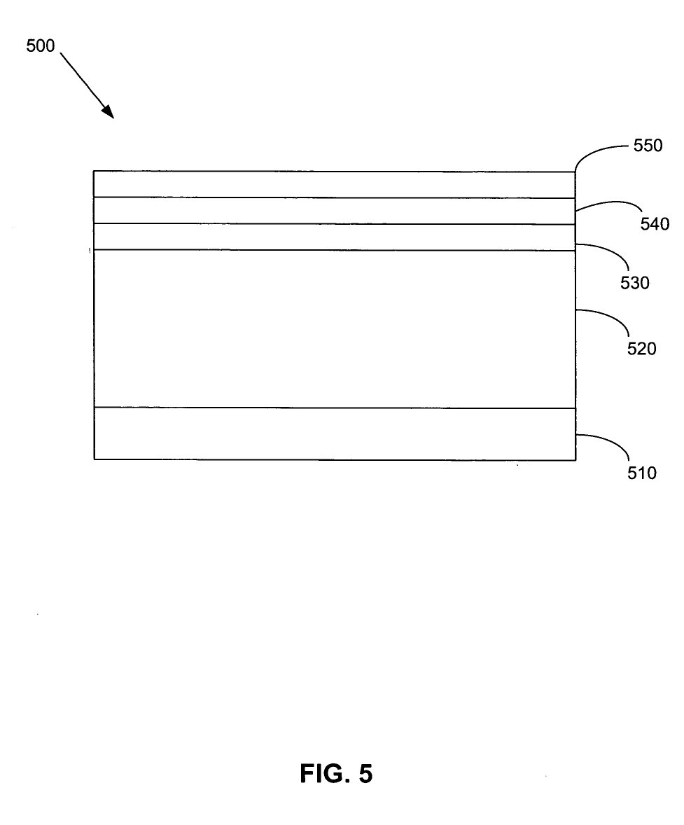

FIG. 5 is a cross-sectional view of a coated floor tile, according to another embodiment of the present invention. The coated floor tile 500 generally comprises a backcoat 510, a tile base 520, a print film 530 or alternatively a transfer print ink (not shown), a cap film 540, and a topcoat 550 comprising a coating made according to the present invention. In a preferred embodiment, the backcoat 510 comprises a urethane backcoat of approximately 0.5-2 mils in thickness. The tile base 520 is approximately 50- 200 mils in thickness, and the print film 530 is approximately 0.5 mils in thickness. The cap film 540 comprises a PVC cap film of approximately 2.8 mils in thickness, and the topcoat 550 comprises a thickness of approximately 1-3 mils.

A preferred UV-curable coating mixture for use with tile substrates comprises texture-generating nylon particles and alumina/silane rheological control agents. A more preferred coating mixture comprises, by weight, 35.6% ethoxylated trimethylolpropane triacrylate (SR 454, available from Sartomer, Exton, Pa.), 41.3% polyester acrylate (LAROMER PE56F, available from BASF, Charlotte, N.C.), 5.79% urethane acrylate (ALUA 1001, available from Congoleum Corporation, Mercerville, N.J.), 0.330% acylphosphine oxide (LUCIRIN TPO, available from BASF, Charlotte, N.C.), 8.000% 3 micron inorganic flatting agent (ACEMATTE OK 412, available from Degussa Corp.), 2.24% prehydrolyzed silane as an RCA coupling agent (CONSURF-1 available from Congoleum, Mercerville, N.J.), 0.5% inorganic RCA (NANOTEK ALUMINA #0100, available from Nanophase Technologies, Burr Ridge, Ill.), and 6.250% 60 micron texture-producing particle (ORGASOL 2002 ES6, available from Atofina, Philadelphia, Pa.) and 0.25% fluorinated acrylate oligomer as the low surface energy additive (CN 4000 available from Sartomer, Exton, Pa.) as the low surface energy additive. As such, a preferred cured coating according to the present invention is that coating produced using the above preferred coating mixture.

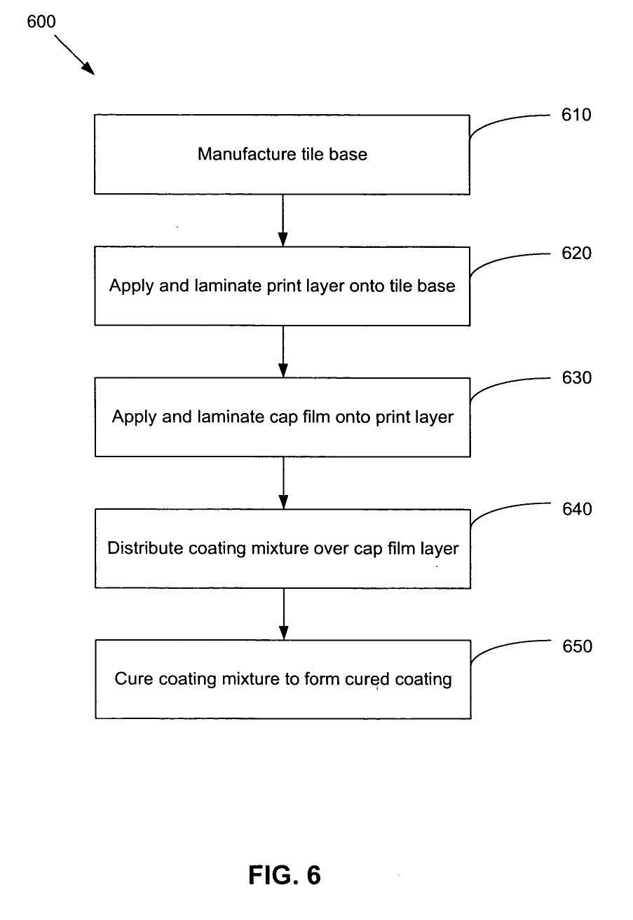

FIG. 6 is a process flow diagram of a process for applying a coating of the present invention to a floor tile according to one embodiment of the present invention. In general, the tile manufacturing process 600 may be a calendering and/or lamination process. In the step 610, a tile base comprising, for example, limestone, is made into a continuous sheet. Then in the step 620, a printed design, also known as the print layer, is applied and laminated to the tile base. Subsequently, as provided in the step 630, a cap film is positioned and may be laminated on top of the printed design for protection. In the step 640, a coating mixture made according to the present invention is applied to the cap. Finally, in the step 650, the coating mixture is cured. It should be appreciated that the general process for constructing tiles can be used to make tiles of any thickness or size.

In a preferred tile manufacturing process, 9″ by 9″, 12″ by 12″, 14″ by 14″, 16″ by 16″, and 18″ by 18″ vinyl tiles are made by first mixing PVC resin, plasticizer, pigments, and a high level (˜80%) of limestone (calcium carbonate) filler in a blender held at 115-135° F. The blended powder effluent is then transferred to a continuous mixer held at 320-340° F. for fusion (i.e. chain entanglement) of the limestone-filled resin into thermoplastic pieces of various sizes. The thermoplastic pieces are next sent to calendering roll operations for partial softening and re-fusion of the limestone-filled resin into the shape of a continuous sheet having an exiting temperature of 250-270° F. and a thickness of 50-200 mils. The continuous sheet of tile base is then carried via conveyor belt to a nip station for lamination of a printed design using either 2 mil thick printed PVC film or 0.5 mil thick printed transfer paper. The latter case involves transferring the ink of a printed design, originally on a paper roll, to the tile base at the lamination nip (the paper is subsequently removed with a re-wind operation immediately following the lamination nip).

Next, the continuous sheet of tile base and laminated print layer is conveyed to another nip for lamination of the “cap film,” which is an ˜3 mil thick PVC film designed to protect the print layer. Both the cap film and print layer applications rely upon the nip pressure and incoming substrate temperature for lamination; the laminating rolls themselves are not heated. The continuous sheet of laminated tile base, print layer, and cap film is then optionally mechanically embossed and finally punched into 9″ by 9″, 12″ by 12″, 14″ by 14″, 16″ by 16″, and 18″ by 18″ tiles using a metal die. The edge material not punched out of the continuous sheet by the die is recycled back into the tile base mixing process.

Any coating mixture made according to the present invention may then be applied to the top of the cap film by metering, followed by subsequent curing of the resin to form a cured coating. The traditionally preferred (but not exclusive) coating application method involves the use of a curtain coater to apply and meter ˜3 mil of uncured UV- curable resin to the cap film surface of the tile. The coated, but uncured, tiles are then sent through a series of UV-processors containing UV lamps to induce cross-linking of the thermosetting resin, in the case where the coating is a radiation-curable coating. (Alternatively, the tiles would be heated to induce the cross-linking in the case where the coating is a thermally-curable coating.) Final processing involves an annealing process at 110-125° F. for up to two days to remove processing stresses and to ensure dimensional stability, as well as an edge grinding process to ensure that smooth edges are present for proper field installation. A thermosetting urethane backcoat may also be applied with a roll- coater to balance the curling stresses imparted on the tile by the cured coating. Such a process is usually performed prior to the application of the coating mixture.

While the foregoing description and drawings represent the preferred embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. For example, even though the coatings of the present invention have been described in the context of sheet flooring and floor tiles, it should be appreciated that the coatings of the present invention may be used in conjunction with any substrate to which the coating may adhere. Substrates that may be used include those containing plastic such as polyvinyl chloride, metal, cellulose, fiberglass, wood and ceramic, among others. Therefore, the presently disclosed embodiments are, therefore, to be considered in all respects as illustrative and not restrictive, the scope of the invention being indicated by the appended claims and not limited to the foregoing description.

1. A coated flooring substrate, comprising:
a flooring substrate; and
a coating on said flooring substrate, wherein said coating comprises a cured resin and a low surface energy additive having a fluorocarbon functional group, in which said cured resin and said low surface energy additive each comprise a cured form of a substantially similar reactive group.

2. The coated flooring substrate of claim 1, wherein said flooring substrate is sheet flooring.

3. The coated flooring substrate of claim 1, wherein said flooring substrate is a floor tile.

4. The coated flooring substrate of claim 1, wherein said flooring substrate is a vinyl flooring substrate.

5. The coated flooring substrate of claim 1, wherein said cured resin comprises a cured form of urethane acrylates, ethoxylated diacrylates, ethoxylated trimethylol propane triacrylates and tripropylene glycol diacrylates.

6. The coated flooring substrate of claim 1, wherein said low surface energy additive comprises acrylate fluorocarbons or methacrylate fluorocarbons.

7. The coated flooring substrate of claim 6, wherein said low surface energy additive is selected from the group consisting of: fluorinated acrylate oligomers, fluorinated methacrylate oligomers, fluorinated diacrylate oligomers, fluorinated dimethacrylate oligomers, acrylated perfluoroethers, methacylated perfluoroethers, diacrylated perfluoroethers, dimethacylated perfluoroethers, diacrylated fluorocarbons, dimethacylated fluorocarbons, and combinations thereof.

8. The coated flooring substrate of claim 1, wherein said low surface energy additive comprises a fluorinated acrylate oligomer or a fluorinated methacrylate oligomer.

9. The coated flooring substrate of claim 1, wherein said fluorocarbon functional group comprises a perfluoroether or a perfluoroester.

10. The coated flooring substrate of claim 1, wherein said substantially similar reactive group is selected from the group consisting of an acrylate, a methacrylate, a styrene, an unsaturated polyester, a thiol, a vinyl ether, an unsaturated ester, a maleimide, a N- vinylformamide, an epoxy, an alcohol, an oxetane or a combination thereof.

11. The coated flooring substrate of claim 1, wherein said coating comprises a surface energy of approximately 30 dynes/cm or less.

12. A coated flooring substrate, comprising:
a soft plastic substrate; and
a cured coating on said soft plastic substrate, in which said cured coating comprises a cured resin and a low surface energy additive having a fluorocarbon functional group, in which said cured resin and said low surface energy additive each comprise a cured form of a substantially similar reactive group.

13. The coated flooring substrate of claim 12, wherein said soft plastic substrate is sheet flooring.

14. The coated flooring substrate of claim 12, wherein said soft plastic substrate is a floor tile.

15. The coated flooring substrate of claim 12, wherein said soft plastic substrate is a vinyl flooring substrate.

16. The coated flooring substrate of claim 12, wherein said cured resin comprises a cured form of urethane acrylates, ethoxylated diacrylates, ethoxylated trimethylol propane triacrylates and tripropylene glycol diacrylates.

17. The coated flooring substrate of claim 12, wherein said low surface energy additive comprises acrylate fluorocarbons or methacrylate fluorocarbons.

18. The coated flooring substrate of claim 17, wherein said low surface energy additive is selected from the group consisting of: fluorinated acrylate oligomers, fluorinated methacrylate oligomers, fluorinated diacrylate oligomers, fluorinated dimethacrylate oligomers, acrylated perfluoroethers, methacylated perfluoroethers, diacrylated perfluoroethers, dimethacylated perfluoroethers, diacrylated fluorocarbons, dimethacylated fluorocarbons, and combinations thereof.

19. The coated flooring substrate of claim 12, wherein said low surface energy additive comprises a fluorinated acrylate oligomer or a fluorinated methacrylate oligomer.

20. The coated flooring substrate of claim 12, wherein said fluorocarbon functional group comprises a perfluoroether or a perfluoroester.

21. The coated flooring substrate of claim 12, wherein said substantially similar reactive group is selected from the group consisting of an acrylate, a methacrylate, a styrene, an unsaturated polyester, a thiol, a vinyl ether, an unsaturated ester, a maleimide, a N- vinylformamide, an epoxy, an alcohol, an oxetane or a combination thereof.

22. The coated flooring substrate of claim 12, wherein said coating comprises a surface energy of approximately 30 dynes/cm or less.

23. A coated flooring substrate, comprising:
a flooring substrate; and
a coating on said flooring substrate, wherein said coating comprises a cured resin and a low surface energy additive having an acrylated silicone functional group, in which said cured resin and said low surface energy additive each comprise a cured form of a substantially similar reactive group.

24. The coated flooring substrate of claim 23, wherein said flooring substrate is sheet flooring.

25. The coated flooring substrate of claim 23, wherein said flooring substrate is a floor tile.

26. The coated flooring substrate of claim 23, wherein said flooring substrate is a vinyl flooring substrate.

27. The coated flooring substrate of claim 23, wherein said cured resin comprises a cured form of urethane acrylates, ethoxylated diacrylates, ethoxylated trimethylol propane triacrylates and tripropylene glycol diacrylates.

28. The coated flooring substrate of claim 23, wherein said low surface energy additive comprises diacrylated poly-dimethylsiloxane or dimethacrylated poly-dimethylsiloxane.

29. The coated flooring substrate of claim 23, wherein said substantially similar reactive group is selected from the group consisting of an acrylate, a methacrylate, a styrene, an unsaturated polyester, a thiol, a vinyl ether, an unsaturated ester, a maleimide, a N- vinylformamide, an epoxy, an alcohol, an oxetane or a combination thereof.

30. The coated flooring substrate of claim 1, wherein said coating comprises a surface energy of approximately 30 dynes/cm or less.

31. A coated flooring substrate, comprising:
a vinyl flooring substrate; and
a coating on said flooring substrate, wherein said coating comprises a cured acrylate resin and a low surface energy additive comprising an acrylated fluorocarbon and wherein said coating has a surface tension less than a surface tension for said coating without said low surface energy additive.

32. The coated flooring substrate of claim 31, wherein said flooring substrate is sheet flooring.

33. The coated flooring substrate of claim 31, wherein said flooring substrate is a floor tile.

34. The coated flooring substrate of claim 31, wherein said cured resin comprises a cured form of urethane acrylates, ethoxylated diacrylates, ethoxylated trimethylol propane triacrylates and tripropylene glycol diacrylates.

35. The coated flooring substrate of claim 31, wherein said low surface energy additive comprises acrylate fluorocarbons or methacrylate fluorocarbons.

36. The coated flooring substrate of claim 35, wherein said low surface energy additive is selected from the group consisting of: fluorinated acrylate oligomers, fluorinated methacrylate oligomers, fluorinated diacrylate oligomers, fluorinated dimethacrylate oligomers, acrylated perfluoroethers, methacylated perfluoroethers, diacrylated perfluoroethers, dimethacylated perfluoroethers, diacrylated fluorocarbons, dimethacylated fluorocarbons, and combinations thereof.

37. The coated flooring substrate of claim 31, wherein said low surface energy additive comprises a fluorinated acrylate oligomer or a fluorinated methacrylate oligomer.

38. The coated flooring substrate of claim 31, wherein said fluorocarbon functional group comprises a perfluoroether or a perfluoroester.

39. The coated flooring substrate of claim 31, wherein said substantially similar reactive group is selected from the group consisting of an acrylate, a methacrylate, a styrene, an unsaturated polyester, a thiol, a vinyl ether, an unsaturated ester, a maleimide, a N- vinylformamide, an epoxy, an alcohol, an oxetane or a combination thereof.

40. The coated flooring substrate of claim 31, wherein said coating comprises a surface energy of approximately 30 dynes/cm or less.

41. A coating mixture for application on a substrate, comprising:
a radiation-curable resin;
an initiator; and
a low surface energy additive having a fluorocarbon functional group, in which said radiation-curable resin and said low surface energy additive each comprise a substantially similar reactive group.

42. The coating mixture of claim 41, wherein said radiation-curable resin comprises urethane acrylates, ethoxylated diacrylates, ethoxylated trimethylol propane triacrylates and tripropylene glycol diacrylates.

43. The coating mixture of claim 41, wherein said radiation-curable resin comprises urethane acrylates, ethoxylated diacrylates, ethoxylated trimethylol propane triacrylates and tripropylene glycol diacrylates.

44. The coating mixture of claim 41, wherein said low surface energy additive comprises acrylate fluorocarbons or methacrylate fluorocarbons.

45. The coating mixture of claim 44, wherein said low surface energy additive is selected from the group consisting of: fluorinated acrylate oligomers, fluorinated methacrylate oligomers, fluorinated diacrylate oligomers, fluorinated dimethacrylate oligomers, acrylated perfluoroethers, methacylated perfluoroethers, diacrylated perfluoroethers, dimethacylated perfluoroethers, diacrylated fluorocarbons, dimethacylated fluorocarbons, and combinations thereof.

46. The coating mixture of claim 41, wherein said low surface energy additive comprises a fluorinated acrylate oligomer or a fluorinated methacrylate oligomer.

47. The coating mixture of claim 41, wherein said fluorocarbon functional group comprises a perfluoroether or a perfluoroester.

48. The coating mixture of claim 41, wherein said substantially similar reactive group is selected from the group consisting of an acrylate, a methacrylate, a styrene, an unsaturated polyester, a thiol, a vinyl ether, an unsaturated ester, a maleimide, a N-vinylformamide, an epoxy, an alcohol, an oxetane or a combination thereof.
